(19) United States
(12) Patent Application Publication
(10) Pub. No.: US 2017/0242366 A1
(43) Pub. Date: Aug. 24, 2017

(54) ELECTROSTATIC CHARGE IMAGE DEVELOPING WHITE TONER, ELECTROSTATIC CHARGE IMAGE DEVELOPER, AND TONER CARTRIDGE

(71) Applicant: FUJI XEROX CO., LTD., Tokyo (JP)

(72) Inventors: Satoshi KAMIWAKI, Kanagawa (JP); Tetsuya TAGUCHI, Kanagawa (JP); Masaru TAKAHASHI, Kanagawa (JP); Shotaro TAKAHASHI, Kanagawa (JP); Tomoaki TANAKA, Kanagawa (JP)

(73) Assignee: FUJI XEROX CO., LTD., Tokyo (JP)

(21) Appl. No.: 15/222,655

(22) Filed: Jul. 28, 2016

(30) Foreign Application Priority Data
Feb. 18, 2016 (JP) 2016-028970

(51) Int. Cl. G03G 9/00

(52) U.S. Cl. CPC G03G 15/0865; G03G 9/0902; G03G 9/091; G03G 9/0924; G03G 9/10

(57) ABSTRACT

An electrostatic charge image developing white toner includes a white toner particle and a yellow toner particle that includes an organic yellow pigment, wherein a content ratio (by number) of the yellow toner particles to all of toner particles included in the toner is from 0.01% by number to 3% by number.

### CROSS-REFERENCE TO RELATED APPLICATIONS

This application is based on and claims priority under 35 USC 119 from Japanese Patent Application No. 2016-028970 filed Feb. 18, 2016.

### BACKGROUND

1. Technical Field

The present invention relates to an electrostatic charge image developing white toner, an electrostatic charge image developer, and a toner cartridge.

2. Related Art

In the related art, a technique of using a white toner to form an electrophotographic image is known.

### SUMMARY

According to an aspect of the invention, there is provided an electrostatic charge image developing white toner including:

a white toner particle; and

a yellow toner particle that includes an organic yellow pigment,

wherein a content ratio (by number) of the yellow toner particles to all of toner particles included in the toner is from 0.01% by number to 3% by number.

### BRIEF DESCRIPTION OF THE DRAWINGS

Exemplary embodiments of the present invention will be described in detail based on the following figures, wherein:

FIG. 1 is a diagram schematically showing a configuration of an example of an image forming apparatus according to an exemplary embodiment of the invention; and

FIG. 2 is a diagram schematically showing a configuration of an example of a process cartridge according to an exemplary embodiment of the invention.

### DETAILED DESCRIPTION

Hereinafter, an exemplary embodiment which is an example of the invention will be described. Electrostatic Charge Image Developing White Toner

An electrostatic charge image developing white toner according to the exemplary embodiment (hereinafter, also referred to simply as “white toner” or “toner”) includes: white toner particles; and yellow toner particles that include an organic yellow pigment. A content ratio (by number) of the yellow toner particles to all of the toner particles in the white toner is from 0.01% by number to 3% by number.

By adjusting the content ratio of the yellow toner particles in the white toner according to the exemplary embodiment to the above-described range, a change in the color of a formed image caused by irradiation of ultraviolet rays is prevented.

The reason why this effect is exhibited is presumed to be as follows.

In the related art, a white toner is used due to, for example, its high undercoating hiding properties. For example, a white toner is used to form an image on a color sheet having a color other than white or to form an undercoat layer of a color image having a color other than white.

Here, the white pigment included in the white toner has a high reflectance of ultraviolet rays than other pigments (pigments having a color other than white). Therefore, a binder resin included in the white toner is in an environment which is likely to be exposed to ultraviolet rays. When an image which is formed using the white toner is exposed to ultraviolet rays, a change in color such as yellowing may occur. It is presumed that the change in color such as yellowing occurs by the binder resin being decomposed when exposed to ultraviolet rays.

On the other hand, in the exemplary embodiment, firstly, the white toner includes a specific amount of yellow toner particles including an organic yellow pigment which is likely to absorb a larger amount of ultraviolet rays than a white pigment and which is likely to be decomposed when absorbing ultraviolet rays. As a result, the organic yellow pigment functions to absorb ultraviolet rays, reduces the amount of ultraviolet rays absorbed by the binder resin, and thus reduces a change in the color of an image.

Secondly, the organic yellow pigment exhibits a less yellow color when absorbing ultraviolet rays and decomposed. Therefore, a trade-off relationship is established between the above-described phenomenon and yellowing caused when the binder resin absorbs ultraviolet rays and is decomposed. As a result, a change in the color of an image is prevented.

In the white toner, the white toner particle may include titanium oxide as the white pigment. According to the exemplary embodiment, even in a case where the white toner particle includes titanium oxide, a reduction in the glossiness of an image is prevented.

The reason why this effect is exhibited is presumed to be as follows.

Titanium oxide exhibits a photocatalyst effect with respect to ultraviolet rays. Therefore, due to the photocatalyst effect, a binder resin may be decomposed, which may cause a phenomenon (chalking) in which the glossiness of an image is reduced.

On the other hand, in the exemplary embodiment, the organic yellow pigment included in the yellow toner particle functions to absorb ultraviolet rays. Therefore, the amount of ultraviolet rays absorbed by a binder resin is reduced, and chalking caused by the decomposition of the binder resin is prevented.

Content Ratio of Yellow Toner Particles

A content ratio (by number) of the yellow toner particles to all of the toner particles in the white toner is from 0.01% by number to 3% by number. The content ratio of the yellow toner particles is preferably from 0.10% by number to 2.50% by number.

When the content ratio of the yellow toner particles is lower than 0.01% by number, it is difficult to obtain the effect of reducing a change in the color of an image caused by irradiation of ultraviolet rays. On the other hand, when the content ratio of the yellow toner particles is higher than 3% by number, white desired from the white toner may not be obtained.

It is preferable that the remainder in all of the toner particles included in the white toner is white toner particles.

Here, the content ratio (by number) of the yellow toner particles in all of the toner particles is measured using the following method.

First, several milligrams of the toner to be measured are placed on a glass slide, one drop of silicone oil is dropped thereon, and the components are mixed with each other using a spatula to disperse the toner. A cover glass covers the glass slide and is pressed so as to remove bubbles. As a result, a sample for observing the toner is prepared.

The obtained sample for observing the toner is observed with an optical microscope (ECLIPSE LV100, manufactured by Nikon Corporation) under settings of an epi-illumination mode, ocular lens magnification: 10 times, and objective lens magnification: 10 times. By displaying an image of the sample using a PC software “Leica Application Suite 4.10” through an interface (DFC-500, a digital camera manufactured by Leica Camera AG), the toner particles may be distinguished from each other.

In the above-described image obtained from the sample for observing the toner, the RGB value of one point at the center of one toner particle is extracted, and this process is repeated for all of the toner particles. The number of yellow toner particles and the number of white toner particles in all the particles of the image are counted, and a ratio of the number of yellow toner particles to the total number of all of the toner particles is calculated.

Observation Conditions

In order to extract the RGB value of one toner particle in the image, an image of the toner particle is displayed using a PC software “Leica Application Suite 4.10”, an exposure value, a gain value, a saturation value, and a gamma value are adjusted to 683 (ms), 3.2, 1.6, and 6.18, and the RGB value of a toner particle portion in the obtained image is extracted using an arbitrary image retouching software.

In this specification, “the white toner particles” refer to toner particles in which, when the sample is observed under the above-described observation conditions, the RGB value of the image obtained using the above-described method is R value: 250 or higher, G value: 250 or higher, and B value: 250 or higher.

On the other hand, “the yellow toner particles” refer to toner particles in which, when the sample is observed under the above-described observation conditions, the RGB value of the image obtained using the above-described method is R value: 230 or higher, G value: 230 or higher, and B value: 100 or lower.

Hereinafter, each component constituting the white toner according to the exemplary embodiment will be described.

The white toner according to the exemplary embodiment includes: white toner particles; and yellow toner particle having a content ratio in the above-described range. Optionally, the respective toner particles may include external additives.

The white toner particles include a white pigment and a binder resin and optionally further include a release agent and other additives.

The yellow toner particles include an organic yellow pigment and a binder resin and optionally further include a release agent and other additives.

Hereinafter, both of the white toner particles and the yellow toner particles will be collectively referred to simply as “toner particles”.

### White Toner Particles and Yellow Toner Particles

### White Pigment

The white toner particle includes a white pigment.

Examples of the white pigment include titanium oxide (TiO₂, titania), zinc oxide (ZnO, zinc flower), calcium carbonate (CaCO₃), basic lead carbonate (2PbCO₃Pb(OH)₂, lead white), zinc sulfide-barium sulfate mixture (lithopone), zinc sulfide (ZnS), silicon dioxide (SiO₂, silica), and alumina oxide (Al₂O₃, alumina). Among these, titanium oxide or zinc oxide is preferable, and titanium oxide is more preferable.

As the white pigment, one kind may be used alone, or two or more kinds may be used in combination. Optionally, the white pigment may be surface-treated, or may be used in combination with a dispersant.

The content of the white pigment in the white toner particles is preferably from 15% by weight to 70% by weight and more preferably from 20% by weight to 60% by weight.

### Organic Yellow Pigment

The yellow toner particle includes an organic yellow pigment.

Examples of the organic yellow pigment include C.I. Pigment Yellow 1, C.I. Pigment Yellow 2, C.I. Pigment Yellow 3, C.I. Pigment Yellow 6, C.I. Pigment Yellow 12, C.I. Pigment Yellow 13, C.I. Pigment Yellow 14, C.I. Pigment Yellow 15, C.I. Pigment Yellow 16, C.I. Pigment Yellow 17, C.I. Pigment Yellow 55, C.I. Pigment Yellow 62, C.I. Pigment Yellow 65, C.I. Pigment Yellow 73, C.I. Pigment Yellow 74, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 100, C.I. Pigment Yellow 104, C.I. Pigment Yellow 109, C.I. Pigment Yellow 110, C.I. Pigment Yellow 111, C.I. Pigment Yellow 120, C.I. Pigment Yellow 127, C.I. Pigment Yellow 128, C.I. Pigment Yellow 129, C.I. Pigment Yellow 138, C.I. Pigment Yellow 139, C.I. Pigment Yellow 151, C.I. Pigment Yellow 152, C.I. Pigment Yellow 154, C.I. Pigment Yellow 155, C.I. Pigment Yellow 166, C.I. Pigment Yellow 167, C.I. Pigment Yellow 168, C.I. Pigment Yellow 174, C.I. Pigment Yellow 175, C.I. Pigment Yellow 176, C.I. Pigment Yellow 180, C.I. Pigment Yellow 181, C.I. Pigment Yellow 185, C.I. Pigment Yellow 191, C.I. Pigment Yellow 191:1, C.I. Pigment Yellow 194, C.I. Pigment Yellow 213, C.I. Pigment Yellow 214, and C.I. Pigment Yellow 219;

C.I. Vat Yellow 1, C.I. Vat Yellow 3, and C.I. Vat Yellow 20;

Mineral Fast Yellow, Nable Yellow, Naphtol Yellow S, Hansa Yellow G, and Permanent Yellow NCG;

C.I. Solvent Yellow 9, C.I. Solvent Yellow 17, C.I. Solvent Yellow 19, C.I. Solvent Yellow 24, C.I. Solvent Yellow 31, C.I. Solvent Yellow 35, C.I. Solvent Yellow 44, C.I. Solvent Yellow 58, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 100, C.I. Solvent Yellow 102, C.I. Solvent Yellow 103, C.I. Solvent Yellow 104, C.I. Solvent Yellow 105, C.I. Solvent Yellow 112, C.I. Solvent Yellow 162, and C.I. Solvent Yellow 163.

As the organic yellow pigment, a monoazo pigment having one azo group (—N═N—) in the molecular structure or a diazo pigment having two azo groups (—N═N—) in the molecular structure is preferably used. Among the organic yellow pigments, the monoazo pigment or the diazo pigment have low light fastness. By adding at least one of the monoazo pigment and the diazo pigment to the yellow toner particles, the degree of a change in the color of an image caused by exposure to ultraviolet rays may be further reduced.

Examples of the monoazo pigment and the diazo pigment include C.I. Pigment Yellow 1, C.I. Pigment Yellow 3, C.I. Pigment Yellow 6, C.I. Pigment Yellow 12, C.I. Pigment Yellow 14, C.I. Pigment Yellow 17, C.I. Pigment Yellow 55, C.I. Pigment Yellow 65, C.I. Pigment Yellow 73, C.I. Pigment Yellow 74, C.I. Pigment Yellow 81, C.I. Pigment Yellow 83, C.I. Pigment Yellow 95, C.I. Pigment Yellow 97, C.I. Pigment Yellow 100, C.I. Pigment Yellow 111, C.I. Pigment Yellow 120, C.I. Pigment Yellow 128, C.I. Pigment Yellow 151, C.I. Pigment Yellow 152, C.I. Pigment Yellow 154, C.I. Pigment Yellow 155, C.I. Pigment Yellow 166, C.I. Pigment Yellow 167, C.I. Pigment Yellow 175, C.I. Pigment Yellow 180, C.I. Pigment Yellow 181, C.I. Pigment Yellow 191, C.I. Pigment Yellow 191:1, C.I. Pigment Yellow 194, C.I. Pigment Yellow 213, C.I. Pigment Yellow 214, and C.I. Pigment Yellow 219. Among these, C.I. Pigment Yellow 74, C.I. Pigment Yellow 155, or C.I. Pigment Yellow 180 is preferable.

In addition, as the organic yellow pigment, an isoindoline pigment having an isoindoline structure in the molecular structure is preferably used. Among the organic yellow pigments, the isoindoline pigment has high light fastness. By adding isoindoline pigment to the yellow toner particles, the continuousness of the reduction of a change in the color of an image caused by exposure to ultraviolet rays may be improved.

As the isoindoline pigment, C.I. Pigment Yellow 185 or C.I. Pigment Yellow 139 is preferable.

As the organic yellow pigment, one kind may be used alone, or two or more kinds may be used in combination. Optionally, the organic yellow pigment may be surface-treated, or may be used in combination with a dispersant.

In addition, the yellow toner particles may include colorants having other colors, and examples thereof include orange pigments (for example, C.I. Pigment Orange 1, C.I. Pigment Orange 5, C.I. Pigment Orange 13, C.I. Pigment Orange 15, C.I. Pigment Orange 16, C.I. Pigment Orange 31, C.I. Pigment Orange 34, C.I. Pigment Orange 36, C.I. Pigment Orange 38, C.I. Pigment Orange 43, C.I. Pigment Orange 61, C.I. Pigment Orange 62, C.I. Pigment Orange 64, C.I. Pigment Orange 67, C.I. Pigment Orange 71, C.I. Pigment Orange 72, C.I. Pigment Orange 73, or C.I. Pigment Orange 74) and red colorants (for example, C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 21, C.I. Pigment Red 22, C.I. Pigment Red 23, C.I. Pigment Red 31, C.I. Pigment Red 32, C.I. Pigment Red 38, C.I. Pigment Red 41, C.I. Pigment Red 48, C.I. Pigment Red 48:1, C.I. Pigment Red 48:2, C.I. Pigment Red 48:3, C.I. Pigment Red 48:4, C.I. Pigment Red 49, C.I. Pigment Red 52, C.I. Pigment Red 53:1, C.I. Pigment Red 54, C. I . Pigment Red 57:1, C.I. Pigment Red 58, C.I. Pigment Red 60:1, C.I. Pigment Red 63, C.I. Pigment Red 64:1, C.I. Pigment Red 68, C.I. Pigment Red 81:1, C.I. Pigment Red 81:4, C.I. Pigment Red 83, C.I. Pigment Red 88, C.I. Pigment Red 89, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 170, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 206, C.I. Pigment Red 207, C.I. Pigment Red 208, C.I. Pigment Red 209, C.I. Pigment Red 210, C.I. Pigment Red 220, C.I. Pigment Red 221, C.I. Pigment Red 238, C.I. Pigment Red 242, C.I. Pigment Red 245, C.I. Pigment Red 253, C.I. Pigment Red 254, C.I. Pigment Red 255, C.I. Pigment Red 256, C.I. Pigment Red 258, C.I. Pigment Red 264, C.I. Pigment Red 266, C.I. Pigment Red 269, C.I. Pigment Violet 19, C.I. Solvent Red 1, C.I. Solvent Red 3, C.I. Solvent Red 8, C.I. Solvent Red 23, C.I. Solvent Red 24, C.I. Solvent Red 25, C.I. Solvent Red 27, C.I. Solvent Red 30, C.I. Solvent Red 49, C.I. Solvent Red 52, C.I. Solvent Red 58, C.I. Solvent Red 63, C.I. Solvent Red 81, C.I. Solvent Red 82, C.I. Solvent Red 83, C.I. Solvent Red 84, C.I. Solvent Red 100, C.I. Solvent Red 109, C.I. Solvent Red 111, C.I. Solvent Red 121, C.I. Solvent Red 122, C.I. Disperse Red 9, C.I. Basic Red 1, C.I. Basic Red 2, C.I. Basic Red 9, C.I. Basic Red 12, C.I. Basic Red 13, C.I. Basic Red 14, C.I. Basic Red 15, C.I. Basic Red 17, C.I. Basic Red 18, C.I. Basic Red 22, C.I. Basic Red 23, C.I. Basic Red 24, C.I. Basic Red 27, C.I. Basic Red 29, C.I. Basic Red 32, C.I. Basic Red 34, C.I. Basic Red 35, C.I. Basic Red 36, C.I. Basic Red 37, C.I. Basic Red 38, C.I. Basic Red 39, C.I. Basic Red 40, red iron oxide, cadmium red, red lead, mercuric sulfide, cadmium, Permanent Red 4R, Lithol Red, pyrazolone red, watching red, calcium salt, Lake Red D, Brilliant Carmine 6B, Eosin Lake, Rhodamine Lake B, Alizarin Lake, or Brilliant Carmine 3B).

The total content of all the colorants, which include the organic yellow pigment, in the yellow toner particles is preferably from 2% by weight to 20% by weight and more preferably from 4% by weight to 10% by weight. It is preferable that all the colorants contained in the yellow toner particles belong to an organic yellow pigment.

Next, a composition other than the pigments constituting the white toner particles and the yellow toner particles will be described. Hereinafter, the white pigment, the organic yellow pigment, other pigments and dyes, and the like included in the toner particles will be collectively referred to simply as “colorant”.

### Binder Resin

Examples of the binder resin include vinyl resins made of a homopolymer of one monomer or copolymers of two or more monomers selected from the following monomers: styrenes (for example, styrene, parachlorostyrene, and α-methylstyrene); (meth)acrylates (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate); ethylenically unsaturated nitriles (for example, acrylonitrile and methacrylonitrile); vinyl ethers (for example, vinyl methyl ether and vinyl isobutyl ether); vinyl ketones (vinyl methyl ketone, vinyl ethyl ketone, and vinyl isopropenyl ketone); and olefins (for example, ethylene, propylene, and butadiene).

Examples of the binder resin include non-vinyl resins such as epoxy resins, polyester resins, polyurethane resins, polyamide resins, cellulose resins, polyether resins, and modified rosins; mixtures of the non-vinyl resins and the vinyl resins; and graft polymers obtained by polymerization of vinyl monomers in the presence of the non-vinyl resins.

Among these binder resins, one kind may be used alone, two or more kinds may be used in combination.

As the binder resin, a polyester resin is preferable.

Examples of the polyester resin include well-known polyester resins.

Examples of the polyester resin include a polycondensate of a polyvalent carboxylic acid and a polyol. As the polyester resin, a commercially available polyester resin or a synthetic polyester resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, or sebacic acid), alicyclic dicarboxylic acids (for example, cyclohexanedicarboxylic acid), aromatic dicarboxylic acids (for example, terephthalic acid, isophthalic acid, phthalic acid, or naphthalenedicarboxylic acid), and anhydrides or lower (for example, from 1 to 5 carbon atoms) alkyl esters thereof. Among these, for example, an aromatic dicarboxylic acid is preferable as the polyvalent carboxylic acid.

As the polyvalent carboxylic acid, a dicarboxylic acid and a trivalent or higher valent carboxylic acid having a crosslinking structure or a branched structure may be used in combination. Examples of the trivalent or higher valent carboxylic acid include trimellitic acid, pyromellitic acid, and anhydrides or lower (for example, from 1 to 5 carbon atoms) alkyl esters thereof.

As the polyvalent carboxylic acid, one kind may be used alone, or two or more kinds may be used in combination.

Examples of the polyol include aliphatic diols (for example, ethylene glycol, diethylene glycol, triethylene glycol, propylene glycol, butanediol, hexanediol, or neopentyl glycol), alicyclic diols (for example, cyclohexanediol, cyclohexane dimethanol, or hydrogenated bisphenol A), and aromatic diols (for example, an ethylene oxide adduct of bisphenol A or a propylene oxide adduct of bisphenol A). Among these, as the polyol, for example, an aromatic dial or an alicyclic dial is preferable, and an aromatic dial is more preferable.

As the polyol, a diol and a triol or higher polyol having a crosslinking structure or a branched structure may be used in combination. Examples of the triol or higher polyol include glycerin, trimethylolpropane, and pentaerythritol.

As the polyol, one kind may be used alone, or two or more kinds may be used in combination.

The glass transition temperature (Tg) of the polyester resin is preferably from 50° C. to 80° C. and more preferably from 50° C. to 65° C.

The glass transition temperature is calculated from a DSC curve obtained from differential scanning calorimetry (DSC), more specifically, from “extrapolated glass transition starting temperature” described in a method of calculating a glass transition temperature in “Testing methods for transition temperatures of plastics” of JIS K 7121-1987.

The weight average molecular weight (Mw) of the polyester resin is preferably from 5,000 to 1,000,000, and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100 and more preferably from 2 to 60.

The weight average molecular weight and the number average molecular weight are measured by gel permeation chromatography (GPC). In the measurement of the molecular weight by GPC, HLC-8120 GPC (manufactured by Tosoh Corporation) is used as a measuring device, and TSKgel SUPER HM-M (15 cm; manufactured by Tosoh Corporation) is used as a column, and THF is used as a solvent. The weight average molecular weight and the number average molecular weight are calculated by using a molecular weight calibration curve obtained by a monodispersed polystyrene standard sample from the measurement result.

The polyester resin is obtained using a well-known preparing method. Specifically, the polyester resin is obtained, for example, using a method including: setting the polymerization temperature to from 180° C. to 230° C.; optionally reducing the internal temperature of the reaction system; and causing a reaction to occur while removing water or an alcohol produced during condensation.

In a case where raw material monomers are not soluble or compatible at a reaction temperature, a high boiling point solvent as a solubilizer may be added to dissolve the monomers. In this case, the polycondensation reaction is performed while removing the solubilizer. In a case where a monomer having poor compatibility is present during a copolymerization reaction, the monomer having poor compatibility and an acid or an alcohol to be polycondensed with the monomer may be condensed first, and then the obtained condensate may be polycondensed with a major component.

The content of the binder resin is, for example, preferably from 40% by weight to 95% by weight, more preferably from 50% by weight to 90% by weight, and still more preferably from 60% by weight to 85% by weight with respect to the total amount of the toner particles.

### Release Agent

Examples of the release agent include hydrocarbon waxes; natural waxes such as carnauba wax, rice wax, and candelilla wax; synthetic or mineral and petroleum waxes such as montan wax; and ester waxes such as fatty acid ester and montanic acid ester. The release agent is not limited to these examples.

The melting temperature of the release agent is preferably from 50° C. to 110° C. and more preferably from 60° C. to 100° C.

The melting temperature is calculated from the DSC curve obtained from differential scanning calorimetry (DSC) according to a “melting peak temperature” described in a method of calculating melting temperature in “Testing methods for transition temperatures of plastics” of JIS K 7121-1987.

The content of the release agent is, for example, preferably from 1% by weight to 20% by weight and more preferably from 5% by weight to 15% by weight with respect to the total amount of the toner particles.

### Other Additives

Examples of the other additives include various known additives such as a magnetic material, a charge-controlling agent, and inorganic powder. These additives are included in the toner particles as internal additives.

### Properties of Toner Particles

The toner particles may have a single-layer structure or a so-called core-shell structure including: a core (core particle) and a coating layer (shell layer) that coats the core.

Here, it is preferable that the toner particles having a core-shell structure include: a core that includes a binder resin and optionally further includes other additives such as a colorant and a release agent; and a coating layer that includes a binder resin.

The volume average particle diameter (D50v) of the toner particles is preferably from 2 μm to 10 μm and more preferably from 4 μm to 8 μm.

Various average particle diameters and various particle diameter distribution indices of the toner particles are measured by using COULTER MULTISIZER II (manufactured by Beckman Coulter Co., Ltd.) as a measuring device and using ISOTON-II (manufactured by Beckman Coulter Co., Ltd.) as an electrolytic solution.

During this measurement, from 0.5 mg to 50 mg of a measurement sample is added to 2 ml of an aqueous solution containing 5% of a surfactant (preferably, sodium alkylbenzene sulfonate) as a dispersant. This solution is added to from 100 ml to 150 ml of the electrolytic solution.

The electrolytic solution in which the measurement sample is suspended is dispersed with an ultrasonic disperser for 1 minute. Then, a particle diameter distribution of particles having a particle diameter in a range of from 2 μm to 60 μm is measured using COULTER MULTISIZER II and an aperture having an aperture size of 100 μm. The number of particles to be sampled is 50,000.

Using the measured particle diameter distribution, volume and number cumulative particle diameter distributions are drawn on divided particle diameter ranges (channels) in order from the smallest particle diameter. In addition, particle diameters having cumulative values of 16% by volume and number are defined as a volume average particle diameter D16v and a number average particle diameter D16p, respectively. Particle diameters having cumulative values of 50% by volume and number are defined as a volume average particle diameter D50v and a number average particle diameter D50p, respectively. Particle diameters having cumulative values of 84% by volume and number are defined as a volume average particle diameter D84v and a number average particle diameter D84p, respectively.

Using these values, a volume average particle diameter distribution index (GSDv) is calculated from (D84v/D16v)^{1/2}, and a number average particle diameter distribution index (GSDp) is calculated from (D84p/D16p)^{1/2}.

The shape factor SF1 of the toner particles is preferably from 110 to 150 and more preferably from 120 to 140.

The shape factor SF1 is obtained from the following expression.

Expression: SF1=(ML²/A)×(π/4)×100

In the expression, ML represents an absolute maximum length of a toner particle, and A represents a projected area of a toner particle.

Specifically, the shape factor SF1 is converted to a numerical value by analyzing a microscopic image or a scanning electron microscope (SEM) image using an image analyzer and calculated as follows. That is, an optical microscope image of particles sprayed on a glass slide surface is input to an image analyzer LUZEX through a video camera, maximum lengths and projected areas of 100 particles are obtained to calculate shape factors thereof from the above expression, and an average value thereof is obtained.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

Surfaces of the inorganic particles as the external additive may be treated with a hydrophobizing agent. The hydrophobization treatment may be performed, for example, by dipping the inorganic particles in a hydrophobizing agent. The hydrophobizing agent is not particularly limited, and examples thereof include a silane coupling agent, silicone oil, a titanate coupling agent, and an aluminum coupling agent. Among these, one kind may be used alone, two or more kinds may be used in combination.

The amount of the hydrophobizing agent is from 1 part by weight to 10 parts by weight with respect to 100 parts by weight of the inorganic particles.

Examples of the external additive include resin particles (for example, resin particles of polystyrene, polymethyl methacrylate (PMMA), and melamine resin) and a cleaning aid (for example, particles of metal salts of higher fatty acids such as zinc stearate and fluorine polymers).

The content of the external additive is, for example, preferably from 0.01% by weight to 5% by weight and more preferably from 0.01% by weight to 2.0% by weight with respect to the total amount of the toner particles.

### Preparing Method of Toner

Next, a preparing method of a toner according to the exemplary embodiment will be described.

The toner according to the exemplary embodiment is obtained by preparing the toner particles and externally adding the external additive to the toner particles.

The toner particles may be prepared using either a dry method (for example, a kneading and pulverizing method) or a wet method (for example, an aggregating and coalescing method, a suspension and polymerization method, or a melt and suspension method). The method of preparing the toner particles is not limited to these methods, and a well-known method is adopted.

Among these, an aggregating and coalescing method is preferably used to obtain the toner particles.

Specifically, for example, in a case where toner particles are prepared using the aggregating and coalescing method, the toner particles are prepared through the following processes including: a process (resin particle dispersion preparing process) of preparing a resin particle dispersion in which resin particles which form a binder resin are dispersed; a process (aggregated particle forming process) of forming aggregated particles by aggregating the resin particles (optionally, including other particles) in the resin particle dispersion (optionally in a dispersion in which the resin particle dispersion is mixed with another particle dispersion); and a process (coalescing process) of forming toner particles by heating an aggregated particle dispersion in which the aggregated particles are dispersed to coalesce the aggregated particles.

Hereinafter, each process will be described in detail.

In the following description, a method of obtaining toner particles including a colorant and a release agent will be described, but the colorant and the release agent are optionally used. Additives other than the colorant and the release agent may be added.

### Resin Particle Dispersion Preparing Process

First, a resin particle dispersion in which resin particles which form a binder resin are dispersed and other dispersions, for example, a colorant particle dispersion in which colorant particles are dispersed and a release agent particle dispersion in which release agent particles are dispersed are prepared.

Here, the resin particle dispersion is prepared, for example, by dispersing resin particles in a dispersion medium using a surfactant.

Examples of the dispersion medium used in the resin particle dispersion include an aqueous medium.

Examples of the aqueous medium include water such as distilled water and ion exchange water; and alcohols. Among these, one kind may be used alone, two or more kinds may be used in combination.

Examples of the surfactant include anionic surfactants such as sulfuric acid ester salts, sulfonic acid salts, phosphoric acid esters, and soaps; cationic surfactants such as amine salts and quaternary ammonium salts; and nonionic surfactants such as polyethylene glycol, alkylphenol ethylene oxide adducts, and polyols. Among these, an anionic surfactant or a cationic surfactant is preferably used. A nonionic surfactant maybe used in combination with an anionic surfactant or a cationic surfactant.

As the surfactant, one kind may be used alone, or two or more kinds may be used in combination.

Examples of a method of dispersing resin particles in a dispersion medium to obtain the resin particle dispersion include general methods using a rotary shearing homogenizer or a dispersing machine having a medium such as a ball mill, a sand mill or a dyno mill. Depending on the kind of resin particles, for example, resin particles may be dispersed in the resin particle dispersion using an emulsion phase-inversion method.

In the emulsion phase-inversion method, a resin to be dispersed is dissolved in a hydrophobic organic solvent in which the resin is soluble, a base is added to an organic continuous phase (O phase) to neutralize the organic continuous phase, and then water (W phase) is poured thereinto. As a result, the phase of the resin is inverted from W/O to O/W (so-called phase inversion) so as to be a discontinuous phase, and the resin is dispersed in an aqueous medium in a particle form.

The volume average particle diameter of the resin particles dispersed in the resin particle dispersion is, for example, preferably from 0.01 μm to 1 μm, more preferably from 0.08 μm to 0.8 μm, and still more preferably from 0.1 μm to 0.6 μm.

In order to obtain the volume average particle diameter of the resin particles, using a particle diameter distribution which is obtained from measurement of a laser diffraction particle diameter distribution analyzer (for example, LA-700 manufactured by Horiba Ltd.), a volume cumulative distribution is drawn on divided particle size ranges (channels) in order from the smallest particle size. A particle diameter having a cumulative value of 50% with respect to all the particles is defined as the volume average particle diameter D50v. The volume average particle diameter of other particles in other dispersions are measured using the same method as above.

The content of the resin particles in the resin particle dispersion is preferably from 5% by weight to 50% by weight and more preferably from 10% by weight to 40% by weight.

Using the same preparation method as that of the resin particle dispersion, for example, a colorant particle dispersion and a release agent particle dispersion are prepared. That is, regarding the volume average particle diameter, the dispersion medium, the dispersing method, and the content of the particles in the resin particle dispersion, the same shall be applied to the colorant particles which are dispersed in the colorant particle dispersion and the release agent particles which are dispersed in the release agent particle dispersion.

### Aggregated Particle Forming Process

Next, the resin particle dispersion, the colorant particle dispersion, and the release agent particle dispersion are mixed with each other.

Then, the resin particles, the colorant particles, and the release agent particles are hetero-aggregated in the mixed dispersion to form aggregated particles having a target particle diameter of toner particles which include the resin particles, the colorant particles, and the release agent particles.

Specifically, for example, a coagulant is added to the mixed dispersion, the pH of the mixed dispersion is adjusted to be acidic (for example, to be within a range from 2 to 5), and optionally a dispersion stabilizer is added. Next, the mixed dispersion is heated to the glass transition temperature of the resin particle (specifically, from “(the glass transition temperature of the resin particle) −30° C.” to “(the glass transition temperature of the resin particle) −10° C.”) to aggregate the particles dispersed in the mixed dispersion. As a result, aggregated particles are formed.

In the aggregated particle forming process, for example, the mixed dispersion may be heated after adding a coagulant at room temperature (for example, 25° C.) while stirring the mixed dispersion using a rotary shearing homogenizer, adjusting the pH of the mixed dispersion to be acidic (for example, to be within a range from 2 to 5), and optionally adding a dispersion stabilizer.

Examples of the coagulant include a surfactant having a polarity opposite to that of a surfactant which is used as a dispersant added to the mixed dispersion, an inorganic metal salt, and a divalent or higher metal complex. In particular, in a case where a metal complex is used as the coagulant, the amount of the surfactant used is reduced, and charging characteristics are improved.

Optionally, an additive for forming a complex or a similar bond with metal ions of the coagulant may be used. As this additive, a chelating agent is preferably used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfate.

As the chelating agent, a water-soluble chelating agent may be used. Examples of the chelating agent include oxycarboxylic acids such as tartaric acid, citric acid, or gluconic acid, iminodiacetic acid (IDA), nitrilotriacetic acid (NTA), and ethylenediaminetetraacetic acid (EDTA).

The amount of the chelating agent added is, for example, preferably from 0.01 part by weight to 5.0 parts by weight and more preferably 0.1 part by weight or more and less than 3.0 parts by weight with respect to 100 parts by weight of the resin particles.

### Coalescing Process

Next, the aggregated particle dispersion in which the aggregated particles are dispersed is heated to the glass transition temperature of the resin particle or higher (for example, a temperature which is higher than the glass transition temperature of the resin particle by 10° C. to 30° C.) to coalesce the aggregated particle. As a result, toner particles are formed.

Through the above-described processes, the toner particles are obtained.

Toner particles may be prepared through the following processes including: a process of forming second aggregated particles by obtaining an aggregated particle dispersion in which aggregated particles are dispersed, and then further mixing the aggregated particle dispersion with a resin particle dispersion in which resin particles are dispersed so as to attach the resin particles to surfaces of the aggregated particles; and a process of forming toner particles having a core-shell structure by heating a second aggregated particle dispersion in which the second aggregated particles are dispersed to coalesce the second aggregated particles.

Here, after the coalescing process ends, toner particles formed in the solution undergo well-known processes including a washing process, a solid-liquid separation process, and a drying process. As a result, dry toner particles are obtained.

In the washing process, it is preferable that displacement washing using ion exchange water is sufficiently performed from the viewpoint of charging characteristics. In addition, in the solid-liquid separation process, although there is no particular limitation, it is preferable that suction filtration, pressure filtration, or the like is performed from the viewpoint of productivity. In addition, in the drying process, although there is no particular limitation, it is preferable that freeze drying, air jet drying, fluidized drying, vibration-type fluidized drying, or the like is performed from the viewpoint of productivity.

The white toner according to the exemplary embodiment is manufactured, for example, by preparing the white toner particles and the yellow toner particles separately using the above-described methods, mixing the obtained dry white toner particles and the obtained dry yellow toner particles with each other, and adding an external additive to the mixture. It is preferable that the mixing be performed using a V blender, HENSCHEL mixer, or LODIGE mixer. Further, optionally, coarse particles of the toner are removed, for example, using a vibration sieve or a wind classifier.

### Electrostatic Charge Image Developer

An electrostatic charge image developer according to the exemplary embodiment includes at least the toner according to the exemplary embodiment.

The electrostatic charge image developer according to the exemplary embodiment may be a single-component developer including only the toner according to the exemplary embodiment or a two-component developer in which the toner and a carrier are mixed.

The carrier is not particularly limited, and for example, a well-known carrier may be used. Examples of the carrier include a resin-coated carrier in which surfaces of cores formed of magnetic particles are coated with a coating resin; a magnetic particle-dispersed carrier in which magnetic particles are dispersed in a matrix resin; and a resin-impregnated carrier in which porous magnetic particles are impregnated with a resin.

In the magnetic particle-dispersed carrier or the resin-impregnated carrier, particles constituting the carrier may be used as cores, and the cores may be coated with a coating resin.

Examples of the magnetic particles include magnetic metals such as iron, nickel, and cobalt; and magnetic oxides such as ferrite and magnetite.

Examples of the coating resin and the matrix resin include polyethylene, polypropylene, polystyrene, polyvinylacetate, polyvinylalcohol, polyvinylbutyral, polyvinyl chloride, polyvinyl ether, polyvinyl ketone, vinyl chloride-vinyl acetate copolymers, styrene-acrylic acid copolymers, straight silicone resins having an organosiloxane bond and modified compounds thereof, fluororesins, polyester, polycarbonate, phenol resins, and epoxy resins.

Other additives such as conductive particles maybe added to the coating resin and the matrix resin.

Examples of conductive particles include particles of metals such as gold, silver, and copper; and particles of carbon black, titanium oxide, zinc oxide, tin oxide, barium sulfate, aluminum borate, potassium titanate, and the like.

Here, in order to coat the core with the coating resin, for example, a method is used in which the surfaces of the core particles are coated with a coating layer-forming solution obtained by dissolving the coating resin and optionally various additives in an appropriate solvent. The solvent is not particularly limited and may be selected in consideration of the coating resin to be used, coating suitability, and the like.

Examples of a specific resin coating method include a dipping method in which the cores are dipped in a coating layer-forming solution; a spray method in which a coating layer-forming solution is sprayed on the surfaces of the cores; a fluidized bed method in which a coating layer-forming solution is sprayed on the core particle while floating the cores with flowing air; and a kneader coater method in which the cores of the carrier and a coating layer-forming solution are mixed in a kneader coater, and then a solvent is removed.

A mixing ratio (weight ratio; toner:carrier) of the toner to the carrier in the two-component developer is preferably 1:100 to 30:100 and more preferably 3:100 to 20:100.

### Image Forming Apparatus and Image Forming Method

An image forming apparatus and an image forming method according to the exemplary embodiment will be described.

The image forming apparatus according to the exemplary embodiment includes: an image holding member; a charging unit that charges a surface of the image holding member; an electrostatic charge image forming unit that forms an electrostatic charge image on a charged surface of the image holding member; a developing unit that contains an electrostatic charge image developer and develops the electrostatic charge image, which is formed on the surface of the image holding member, using the electrostatic charge image developer to form a toner image; a transfer unit that transfers the toner image, which is formed on the surface of the image holding member, to a surface of a recording medium; and a fixing unit that fixes the toner image transferred onto the surface of the recording medium. As the electrostatic charge image developer, the electrostatic charge image developer according to the exemplary embodiment is used.

In the image forming apparatus according to the exemplary embodiment, an image forming method (image forming method according to the exemplary embodiment) is performed, the method including: a charging step of charging a surface of an image holding member; an electrostatic charge image forming step of forming an electrostatic charge image on a charged surface of the image holding member; a developing step of developing the electrostatic charge image, which is formed on the surface of the image holding member, using the electrostatic charge image developer according to the exemplary embodiment to form a toner image; a transfer step of transferring the toner image, which is formed on the surface of the image holding member, to a surface of a recording medium; and a fixing step of fixing the toner image transferred onto the surface of the recording medium.

As the image forming apparatus according to the exemplary embodiment, various well-known image forming apparatuses may be used, the apparatuses including: a direct transfer type apparatus in which a toner image formed on a surface of an image holding member is directly transferred to a recording medium; an intermediate transfer type apparatus in which a toner image formed on a surface of an image holding member is primarily transferred to a surface of an intermediate transfer member, and the toner image transferred to the surface of the intermediate transfer member is secondarily transferred to a surface of a recording medium; an apparatus including a cleaning unit that cleans a surface of an image holding member after a toner image is transferred and before charging; and an apparatus including an erasing unit that irradiates a surface of an image holding member with erasing light for erasing charge after a toner image is transferred and before charging.

In the intermediate transfer type apparatus, for example, a transfer unit includes: an intermediate transfer member having a surface to which a toner image is transferred; a primary transfer unit that primarily transfers a toner image, which is formed on a surface of an image holding member, to the surface of the intermediate transfer member; and a secondary transfer unit that secondarily transfers the toner image, which is transferred to the surface of the intermediate transfer member, to a surface of a recording medium.

In the image forming apparatus according to the exemplary embodiment, for example, a portion including the developing unit may have a cartridge structure (process cartridge) which is detachable from the image forming apparatus. As the process cartridge, a process cartridge that contains the electrostatic charge image developer according to the exemplary embodiment and includes the developing unit is preferably used.

In the image forming apparatus according to the exemplary embodiment, not only the white toner according to the exemplary embodiment but also at least one selected from the group consisting of a yellow toner, a magenta toner, a cyan toner, and a black toner may be used.

Hereinafter, an example of the image forming apparatus according to the exemplary embodiment will be described, but the image forming apparatus is not limited thereto. Major components shown in the drawings will be described, and the other components will not be described.

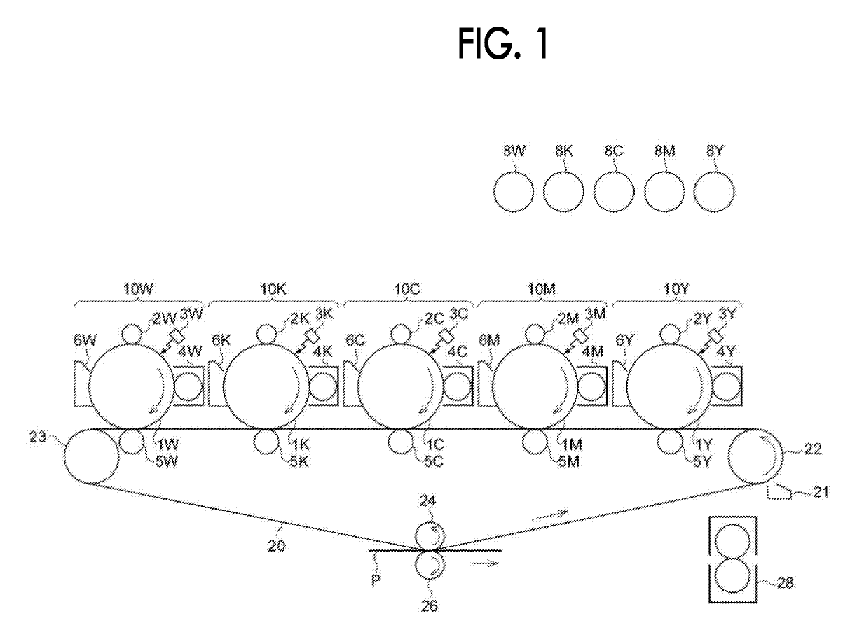

FIG. 1 is a diagram schematically showing a configuration of the image forming apparatus according to the exemplary embodiment which is a quintuple tandem type and an intermediate transfer type image forming apparatus.

The image forming apparatus illustrated in FIG. 1, includes first to fifth electrophotographic image forming units 10Y, 10M, 10C, 10K, and 10W (image forming units) that form images of the respective colors including yellow (Y), magenta (M), cyan (C), black (K), and white (W) based on color-separated image data. These image forming units (hereinafter, also simply referred to as “units”) 10Y, 10M, 10C, 10K, and 10W are horizontally arranged in parallel at predetermined intervals. These units 10Y, 10M, 10C, 10K, and 10W may be process cartridges which are detachable from the image forming apparatus.

An intermediate transfer belt 20 (an example of the intermediate transfer member) extends through a region below the respective units 10Y, 10M, 10C, 10K, and 10W. The intermediate transfer belt 20 is wound around a drive roller 22, a support roller 23, and a counter roller 24 which contacts with the inner surface of the intermediate transfer belt 20. The intermediate transfer belt 20 travels in a direction moving from the first unit 10Y to the fifth unit 10W. In addition, an intermediate transfer member cleaning device 21 is provided on an image holding member-side surface of the intermediate transfer belt 20 to be opposite to the drive roller 22.

In addition, the respective toners of yellow, magenta, cyan, black, and white which are contained in toner cartridges 8Y, 8M, 8C, 8K, and 8W are supplied to developing devices (examples of the developing unit) 4Y, 4M, 4C, 4K, and 4W of the respective units 10Y, 10M, 10C, 10K, and 10W respectively.

Since the first to fifth units 10Y, 10M, 10C, 10K, and 10W have the same configuration, operation, and action, the first unit 10Y which is arranged on an upstream side in the traveling direction of the intermediate transfer belt and forms a yellow image will be described as a representative example.

The first unit 10Y includes a photoreceptor 1Y which functions as the image holding member. In the vicinity of the photoreceptor 1Y, a charging roller 2Y (an example of the charging unit) that charges a surface of the photoreceptor 1Y to a predetermined potential; an exposure device 3Y (an example of the electrostatic charge image forming unit) that exposes the charged surface to a laser beam based on a color-separated image signal to form an electrostatic charge image thereon; a developing device 4Y (an example of the developing unit) that supplies toner to the electrostatic charge image to develop the electrostatic charge image; a primary transfer roller 5Y (an example of the primary transfer unit) that transfers the developed toner image to the intermediate transfer belt 20; and a photoreceptor cleaning device 6Y (an example of the cleaning unit) that removes the toner remaining on the surface of the photoreceptor 1Y after the primary transfer, are arranged in this order.

The primary transfer roller 5Y is arranged inside the intermediate transfer belt 20 and is provided at a position opposite to the photoreceptor 1Y. Further, bias power supplies (not illustrated) are connected to the primary transfer rollers 5Y, 5M, 5C, 5K, and 5W of the respective units to apply primary transfer biases thereto. A controller (not illustrated) controls the respective bias power supply to change the transfer bias values which are applied to the respective primary transfer rollers.

Hereinafter, the operation of forming the yellow image in the first unit 10Y will be described.

First, before the operation, the surface of the photoreceptor 1Y is charged to a potential of −600 V to −800 V by the charging roller 2Y.

The photoreceptor 1Y is formed by laminating a photosensitive layer on a conductive substrate (for example, volume resistivity at 20° C.: 1×10⁻⁶ Ωcm or lower). This photosensitive layer typically has high resistance (resistance of a general resin) but has a property in which, when being irradiated with the laser beam, the specific resistance of the portion irradiated with the laser beam changes. Therefore, the charged surface of the photoreceptor 1Y is irradiated with the laser beam through the exposure device 3Y according to image data for yellow sent from the controller (not illustrated). As a result, an electrostatic charge image having a yellow image pattern is formed on the surface of the photoreceptor 1Y.

The electrostatic charge image is an image which is formed on the surface of the photoreceptor 1Y by charging and is a so-called negative latent image which is formed when the specific resistance of a portion, which is irradiated with the laser beam emitted from the exposure device 3Y, of the photosensitive layer is reduced and the charge flows on the surface of the photoreceptor 1Y, and when the charge remains in a portion which is not irradiated with the laser beam.

The electrostatic charge image formed on the photoreceptor 1Y is rotated to a predetermined development position along with the traveling of the photoreceptor 1Y. At this development position, the electrostatic charge image on the photoreceptor 1Y is developed and visualized as a toner image by the developing device 4Y.

The developing device 4Y contains, for example, an electrostatic charge image developer containing at least a yellow toner and a carrier. The yellow toner is frictionally charged by being agitated in the developing device 4Y to have a charge having the same polarity (negative polarity) as that of a charge on the photoreceptor 1Y and is maintained on a developer roller (an example of the developer holding member). When the surface of the photoreceptor 1Y passes through the developing device 4Y, the yellow toner is electrostatically attached to a latent image portion on the surface of the photoreceptor 1Y which is erased, and the latent image is developed with the yellow toner. The photoreceptor 1Y on which a yellow toner image is formed continuously travels at a predetermined rate, and the toner image developed on the photoreceptor 1Y is transported to a predetermined primary transfer position.

When the yellow toner image on the photoreceptor 1Y is transported to the primary transfer position, a primary transfer bias is applied to the primary transfer roller 5Y, an electrostatic force is applied to the toner image in a direction moving from the photoreceptor 1Y to the primary transfer roller 5Y, and the toner image on the photoreceptor 1Y is transferred to the intermediate transfer belt 20. The transfer bias applied at this time has a positive polarity opposite to the negative polarity of the toner. The first unit 10Y is controlled to, for example, +10 μA by the controller (not shown).

On the other hand, the toner remaining on the photoreceptor 1Y is removed and collected by the photoreceptor cleaning device 6Y.

In addition, primary transfer biases which are applied to the primary transfer rollers 5M, 5C, 5K, and 5W of the second unit 10M and subsequent units, respectively, are controlled in a similarly way to that of the primary transfer bias of the first unit.

In this way, the intermediate transfer belt 20 to which the yellow toner image is transferred by the first unit 10Y is sequentially transported through the second to fifth units 10M, 10C 10K, and 10W, and toner images of the respective colors are transferred and layered.

The intermediate transfer belt 20 to which the five color toner images are transferred and layered by the first to fifth units reaches a secondary transfer portion which is configured with the intermediate transfer belt 20, the counter roller 24, and a secondary transfer roller 26 (an example of the secondary transfer unit), in which the support roller 24 contacts with the inner surface of the intermediate transfer belt, and the secondary transfer roller 26 is arranged on an image holding surface side of the intermediate transfer belt 20. Meanwhile, a recording sheet P (an example of the recording medium) is supplied to a gap at which the secondary transfer roller 26 and the intermediate transfer belt 20 contact with each other at a predetermined timing through a supply mechanism, and a predetermined secondary transfer bias is applied to the counter roller 24. The transfer bias applied at this time has the negative polarity which is the same as the polarity of the toner, and an electrostatic force is applied to the toner image in a direction moving from the intermediate transfer belt 20 to the recording sheet P. As a result, the toner image on the intermediate transfer belt 20 is transferred to the recording sheet P. At this time, the secondary transfer bias is determined depending on a resistance detected by a resistance detecting unit (not illustrated) which detects a resistance of the secondary transfer portion, and the voltage is controlled.

Thereafter, the recording sheet P is transported to a nip portion of a pair of fixing rollers in a fixing device 28 (an example of the fixing unit), and the toner image is fixed onto the recording sheet P to form a fixed image.

Examples of the recording sheet P to which the toner image is transferred include plain paper used for electrophotographic copying machines, printers and the like. As the recording medium, in addition to the recording sheet P, OHP sheets and the like may be used.

In order to improve the smoothness of the image surface after the fixing, the surface of the recording sheet P is preferably smooth, and for example, coated paper obtained by coating the surface of plain paper with a resin or the like, or art paper for printing is suitably used.

The recording sheet P onto which a color image is completely fixed is discharged to an exit port, and a series of the color image formation operations end. Process Cartridge and Toner Cartridge

A process cartridge according to the exemplary embodiment will be described.

The process cartridge according to the exemplary embodiment is detachable from an image forming apparatus and includes: a developing unit that contains the electrostatic charge image developer according to the exemplary embodiment and develops an electrostatic charge image, which is formed on a surface of an image holding member, using the electrostatic charge image developer to form a toner image.

In addition, the process cartridge according to the exemplary embodiment is not limited to the above-described configuration, and may include the developing device and optionally at least one component selected from other units such as an image holding member, a charging unit, an electrostatic charge image forming unit, and a transfer unit.

Hereinafter, an example of the process cartridge according to the exemplary embodiment will be described, but the process cartridge is not limited thereto. Major components shown in the drawings will be described, and the other components will not be described.

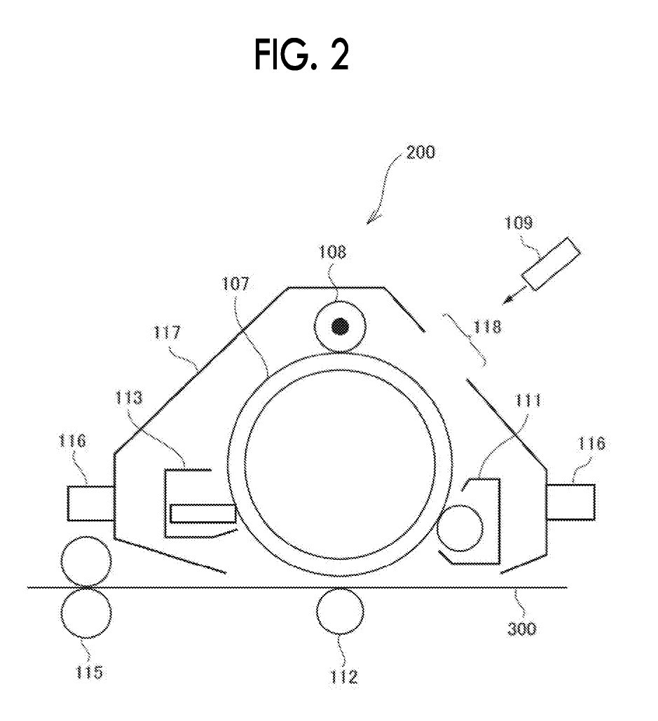

FIG. 2 is a diagram schematically showing a configuration of the process cartridge according to the exemplary embodiment.

A process cartridge 200 illustrated in FIG. 2 is, for example, a cartridge in which a photoreceptor 107 (an example of the image holding member), and a charging roller 108 (an example of the charging unit), a developing device 111 (an example of the developing unit), and a photoreceptor cleaning device 113 (an example of the cleaning unit), which are provided around the photoreceptor 107 are integrally combined in a housing 117 including a mounting rail 116 and an opening 118 for exposure.

In FIG. 2, reference numeral 109 represents an exposure device (an example of the electrostatic charge image forming unit), reference numeral 112 represents a transfer device (an example of the transfer unit), reference numeral 115 represents a fixing device (an example of the fixing unit), and reference numeral 300 represents a recording sheet (an example of the recording medium).

Next, a toner cartridge according to the exemplary embodiment will be described.

The toner cartridge according to the exemplary embodiment contains the toner according to the exemplary embodiment and is detachable from an image forming apparatus. The toner cartridge contains a replenishment toner which is supplied to a developing unit provided in an image forming apparatus. The toner cartridge according to the exemplary embodiment may have a container which contains the toner according to the exemplary embodiment.

The image forming apparatus illustrated in FIG. 1 has a configuration in which the toner cartridges 8Y, 8M, 8C, 8K, and 8W are detachable therefrom, and the developing devices 4Y, 4M, 4C, 4K, and 4W are connected to the toner cartridges corresponding to the respective developing devices (colors) through toner supply pipes (not shown). In addition, when the amount of toner contained in a toner cartridge is insufficient, this toner cartridge is replaced with a new one. An example of the toner cartridge according to the exemplary embodiment is the toner cartridge 8W.

### EXAMPLES

Hereinafter, the exemplary embodiment will be described in detail using Examples but is not limited to these examples.

Hereinafter, unless specified otherwise, “part (s)” and “%” represent “part (s) by weight” and “% by weight”.

### Example 1

### Preparation of White Pigment Particle Dispersion (W1)

Titanium oxide particles (trade name: CR-60-2, manufactured by Ishihara Sangyo Kaisha Ltd.): 210 parts
Anionic surfactant (NEOGEN RK, manufactured by Daiichi Kogyo Seiyaku Co. Ltd.): 10 parts
Ion exchange water: 480 parts

The above-described components are mixed with each other, are stirred using a homogenizer (ULTRA TURRAX T50, manufactured by IKA) for 30 minutes, and are dispersed using a high pressure impact dispersing machine (ALTIMIZER HJP30006, manufactured by Sugino Machine Ltd.) for 1 hour. As a result, a white pigment particle dispersion (W1; solid content: 30%) having a volume average particle diameter of 210 nm in which a white pigment is dispersed is obtained.

### Preparation of Organic Yellow Pigment Particle Dispersion (Y1)

Organic yellow pigment (C.I. Pigment Yellow 74, manufactured by Clariant Japan K.K., trade name: HANSA YELLOW 5GX): 210 parts
Anionic surfactant (NEOGEN RK, manufactured by Daiichi Kogyo Seiyaku Co. Ltd.): 10 parts
Ion exchange water: 480 parts

The above-described components are mixed with each other, are stirred using a homogenizer (ULTRA TURRAX T50, manufactured by IKA) for 30 minutes, and are dispersed using a high pressure impact dispersing machine (ALTIMIZER HJP30006, manufactured by Sugino Machine Ltd.) for 1 hour. As a result, an organic yellow pigment particle dispersion (Y1; solid content: 30%) having a volume average particle diameter of 160 nm in which a yellow pigment is dispersed is obtained.

### Preparation of Resin Particle Dispersion (1)

Terephthalic acid: 30 parts by mol
Fumaric acid: 70 parts by mol
Ethylene oxide adduct of bisphenol A: 5 parts by mol
Propylene oxide adduct of bisphenol A: 95 parts by mol

The above-described materials are put into a flask having an internal capacity of 5 L and including a stirrer, a nitrogen introducing pipe, a temperature sensor, and a rectification tower, the temperature is increased to 210° C. for 1 hour, and 1 part of titanium tetraethoxide is added with respect to 100 parts of the materials. While removing produced water by distillation, the temperature is increased to 230° C. for 0.5 hours, a dehydration condensation reaction is continued at this temperature for 1 hour, and the reactant is cooled. As a result, a polyester resin (1) having a weight average molecular weight of 18,500, an acid value of 14 mgKOH/g, and a glass transition temperature of 59° C. is synthesized.

40 parts of ethyl acetate and 25 parts of 2-butanol are put into a container including a temperature adjusting unit and a nitrogen substitution unit to prepare a mixed solvent. Next, 100 parts of the polyester resin (1) is slowly dissolved in the mixed solvent, and a 10% ammonia aqueous solution (amount equivalent to three times the acid value of the resin by molar ratio) is added to the solution, and the components are stirred for 30 minutes.

Next, the internal atmosphere of the container is substituted with dry nitrogen. While keeping the temperature at 40° C. and stirring the mixed solution, 400 parts of ion exchange water is added dropwise at a rate of 2 part/min and emulsified. After the completion of the dropwise addition, the temperature of the emulsion returns to room temperature (20° C. to 25° C.), and dry nitrogen is bubbled through the emulsion for 48 hours while stirring the emulsion. As a result, the concentration of ethyl acetate and 2 -butanol is reduced to 1,000 ppm, and a resin particle dispersion in which resin particles having a volume average particle diameter of 200 nm are dispersed is obtained. Ion exchange water is added to the resin particle dispersion to adjust the solid content to 30%. As a result, a resin particle dispersion (1) is obtained. Preparation of Release Agent Particle Dispersion (1)
Paraffin wax (HNP-9 manufactured by Nippon Seiro Co. Ltd.): 45 parts
Anionic surfactant (NEOGEN RK, manufactured by Daiichi Kogyo Seiyaku Co. Ltd.): 5 parts
Ion exchange water: 200 parts

The above-described materials are mixed, are heated to 100° C., are dispersed using a homogenizer (ULTRA TURRAX T50, manufactured by IKA), are further dispersed using a MANTON-GAULIN high-pressure homogenizer (manufactured by Gaulin). As a result, a release agent particle dispersion (1) (solid content: 20%) in which release agent particles having a volume average particle diameter of 200 nm are dispersed is obtained.

### Preparation of White Toner Particles (W1)

Ion exchange water: 600 parts
Resin particle dispersion (1): 250 parts
White pigment particle dispersion (W1): 325 parts
Release agent particle dispersion (1): 78 parts
Anionic surfactant (TAYCA POWER, manufactured by Tayca Corporation, solid content: 20%): 8 parts

The above-described materials are put into a stainless steel round bottom flask, and 0.1N nitric acid is added to adjust pH to 3.5. Next, 13 parts of an aqueous solution having an aluminum sulfate concentration of 10% is added. Next, the components are dispersed at 30° C. using a homogenizer (ULTRA TURRAX T50, manufactured by IKA), are heated to 45° C. in a heating oil bath, and are kept at this temperature for 30 minutes.

Next, 240 parts of the resin particle dispersion (1) is added, and the components are kept for 1 hour. An 0.1N aqueous sodium hydroxide solution is added to the dispersion to adjust pH to 8.5, and then the dispersion is heated to 85° C. while stirring the dispersion. This state is kept for 5 hours. Next, the dispersion is cooled to 20° C. at a rate of 20° C./min, is filtered, is sufficiently washed with ion exchange water, and is dried. As a result, white toner particles (W1) having a volume average particle diameter of 7.5 μm is obtained.

### Preparation of Yellow Toner Particles (Y1)

Ion exchange water: 600 parts
Resin particle dispersion (1): 250 parts
Organic yellow pigment particle dispersion (Y1): 325 parts
Release agent particle dispersion (1): 78 parts
Anionic surfactant (TAYCA POWER, manufactured by Tayca Corporation, solid content: 20%): 8 parts

The above-described materials are put into a stainless steel round bottom flask, and 0.1N nitric acid is added to adjust pH to 3.5. Next, 13 parts of an aqueous solution having an aluminum sulfate concentration of 10% is added. Next, the components are dispersed at 30° C. using a homogenizer (ULTRA TURRAX T50, manufactured by IKA), are heated to 45° C. in a heating oil bath, and are kept at this temperature for 30 minutes.

Next, 100 parts of the resin particle dispersion (1) is added, and the components are kept for 1 hour. An 0.1N aqueous sodium hydroxide solution is added to the dispersion to adjust pH to 8.5, and then the dispersion is heated to 85° C. while stirring the dispersion. This state is kept for 5 hours. Next, the dispersion is cooled to 20° C. at a rate of 20° C./min, is filtered, is sufficiently washed with ion exchange water, and is dried. As a result, yellow toner particles (Y1) having a volume average particle diameter of 7.5 μm is obtained.

### Preparation of White Toner

98.25 parts of the white toner particles (W1), 1.75 parts of the yellow toner particles (Y1), and 1.0 parts of silica particles (RY50, manufactured by Nippon Aerosil Co., Ltd.) are mixed with each other using HENSCHEL mixer (manufactured by Mitsui Miike Machinery Co., Ltd.) at a peripheral speed of 30 m/sec for 3 minutes. Next, the mixture is sieved through a vibration sieve having an opening of 45 μm. As a result, a white toner (1) is prepared.

### Preparation of White Developer

Ferrite particles (average particle diameter: 50 μm): 100 parts
Toluene: 14 parts
Styrene-methyl methacrylate copolymer (copolymerization ratio: 15/85): 3 parts
Carbon black: 0.2 parts

The above-described components other than the ferrite particles are dispersed using a sand mill to prepare a dispersion. This dispersion and the ferrite particles are put into a vacuum degassing type kneader and are dried under reduced pressure while stirring the components. As a result, a carrier is obtained.

20 parts of the white toner (1) is mixed with 200 parts of the carrier to obtain a white developer (1).

### Measurement of Content Ratio (by Number) of Yellow Toner Particles

The content ratio (by number) of the yellow toner particles in all of the toner particles is 1.75% by number when measured using the above-described method.

### Example 2

A white developer is prepared using the same method as in “Preparation of White Toner” of Example 1, except that: the amount of the white toner particles (W1) is changed to 99.25 parts; and the amount of the yellow toner particles (Y1) is 0.75 parts.

The content ratio (by number) of the yellow toner particles in all of the toner particles is 0.75% by number.

### Example 3

A white developer is prepared using the same method as in “Preparation of White Toner” of Example 1, except that: the amount of the white toner particles (W1) is changed to 97.25 parts; and the amount of the yellow toner particles (Y1) is 2.75 parts.

The content ratio (by number) of the yellow toner particles in all of the toner particles is 2.75% by number.

### Example 4

A white developer is prepared using the same method as in “Preparation of Organic Yellow Pigment Particle Dispersion (Y1)” of Example 1, except that the organic yellow pigment to be used is changed to C.I. Pigment Yellow 185 (trade name: PALIOTOL YELLOW D1155, manufactured by BASF Japan Ltd.).

### Example 5

A white developer is prepared using the same method as in “Preparation of White Toner” of Example 1, except that: the amount of the white toner particles (W1) is changed to 99.98 parts; and the amount of the yellow toner particles (Y1) is 0.02 parts.

The content ratio (by number) of the yellow toner particles in all of the toner particles is 0.02% by number.

### Example 6

A white developer is prepared using the same method as in “Preparation of White Toner” of Example 1, except that: the amount of the white toner particles (W1) is changed to 99.89 parts; and the amount of the yellow toner particles (Y1) is 0.11 parts.

The content ratio (by number) of the yellow toner particles in all of the toner particles is 0.11% by number.

### Example 7

A white developer is prepared using the same method as in “Preparation of White Toner” of Example 1, except that: the amount of the white toner particles (W1) is changed to 97.55 parts; and the amount of the yellow toner particles (Y1) is 2.45 parts.

The content ratio (by number) of the yellow toner particles in all of the toner particles is 2.45% by number.

### Example 8

A white developer is prepared using the same method as in “Preparation of Organic Yellow Pigment Particle Dispersion (Y1)” of Example 6, except that the organic yellow pigment to be used is changed to C.I. Pigment Yellow 185 (trade name: PALIOTOL YELLOW D1155, manufactured by BASF Japan Ltd.).

The content ratio (by number) of the yellow toner particles in all of the toner particles is 0.11% by number.

### Example 9

A white developer is prepared using the same method as in “Preparation of Organic Yellow Pigment Particle Dispersion (Y1)” of Example 3, except that the organic yellow pigment to be used is changed to C.I. Pigment Yellow 185 (trade name: PALIOTOL YELLOW D1155, manufactured by BASF Japan Ltd.).

The content ratio (by number) of the yellow toner particles in all of the toner particles is 2.75% by number.

### Comparative Example 1

A white developer is prepared using the same method as in “Preparation of White Toner” of Example 1, except that: the amount of the white toner particles (W1) is changed to 100 parts; and the yellow toner particles (Y1) is not added (that is, the content ratio (by number) of the yellow toner particles is 0% by number).

### Comparative Example 2

A white developer is prepared using the same method as in “Preparation of White Toner” of Example 1, except that: the amount of the white toner particles (W1) is changed to 99.999 parts; and the amount of the yellow toner particles (Y1) is 0.001 parts.

The content ratio (by number) of the yellow toner particles in all of the toner particles is 0.001% by number.

### Comparative Example 3

A white developer is prepared using the same method as in “Preparation of White Toner” of Example 1, except that: the amount of the white toner particles (W1) is changed to 95 parts; and the amount of the yellow toner particles (Y1) is 5 parts.

The content ratio (by number) of the yellow toner particles in all of the toner particles is 5% by number.

### Comparative Example 4

A white developer is prepared using the same method as in “Preparation of White Toner” of Example 1, except that: the amount of the white toner particles (W1) is changed to 99.992 parts; and the amount of the yellow toner particles (Y1) is 0.008 parts.

The content ratio (by number) of the yellow toner particles in all of the toner particles is 0.008% by number.

### Comparative Example 5

A white developer is prepared using the same method as in “Preparation of White Toner” of Example 1, except that: the amount of the white toner particles (W1) is changed to 96.9 parts; and the amount of the yellow toner particles (Y1) is 3.1 parts.

The content ratio (by number) of the yellow toner particles in all of the toner particles is 3.1% by number.

### Evaluation

### Change in Color of Image Caused by Irradiation of Ultraviolet Rays

As an image forming apparatus which forms an image for evaluation, DOCUCENTER COLOR F450 (trade name, manufactured by Fuji Xerox Co., Ltd.) is prepared, the white developer is put into a developing unit, and then a white solid image is formed on paper (trade name: KISHU BLACK QUALITY PAPER (thick), manufactured by Hokuetsu Kishu Paper Co., Ltd.) such that the weight of the toner on the paper was 12.0 g/m². The obtained image is evaluated as follows.

Next, SUNTEST CPS+ (trade name, manufactured by Toyo Seiki Seisaku-Sho, Ltd.) is prepared as an ultraviolet ray irradiation apparatus, and the image is irradiated with ultraviolet rays at an irradiation energy of 540 W/m² for 72 hours (short-term irradiation condition) and for 240 hours (long-term irradiation condition).

The degree of a change in the color of the image caused by the irradiation under the short-term irradiation condition and the degree of a change in the color of the image caused by the irradiation under the long-term irradiation condition are calculated, respectively, using the following method.

Using X-RITE 938 (trade name, manufactured by X-Rite Inc.), L*a*b* immediately after the formation of the image (set as L*(1), a*(1), and b*(1)) are measured. In addition, L*a*b* after the irradiation of ultraviolet rays (set as L*(2), a*(2), and b*(2)) are measured again. Based on the following expression, ΔEa*b* is calculated, which indicates the degree of a change in color.

(Expression) ΔEa*b*=[(L*(1)−L*(2))²+(a*(1)−a*(2))²+(b*(1)−b*(2))²]^{1/2}

The results are shown in Table 1.

### Color of Image Immediately After Formation

The color of the image which is formed using the image forming apparatus is determined by visual inspection and is evaluated based on the following criteria. The results are shown in Table 1.

A: white which may be used for a white toner

B: clearly yellow which cannot be used for a white toner

TABLE 1

| | | | Evaluation | | |
|---|---|---|---|---|---|
| | | | | | Color |
| | Yellow Toner Particles | | | | Imme- |
| | | Organic | ΔEa*b* | | diately |
| | Content Ratio | Yellow | (72 | (240 | after |
| | (% by number) | Pigment | Hours) | Hours) | Formation |
| Example 1 | 1.75% by number | PY74 | 0.10 | 0.40 | A |
| Example 2 | 0.75% by number | PY74 | 0.20 | 0.45 | A |
| Example 3 | 2.75% by number | PY74 | 0.25 | 0.60 | A |
| Example 4 | 1.75% by number | PY185 | 0.30 | 0.35 | A |
| Example 5 | 0.02% by number | PY74 | 0.30 | 0.50 | A |
| Example 6 | 0.11% by number | PY74 | 0.15 | 0.43 | A |
| Example 7 | 2.45% by number | PY74 | 0.22 | 0.50 | A |
| Example 8 | 0.11% by number | PY185 | 0.35 | 0.40 | A |
| Example 9 | 2.75% by number | PY185 | 0.40 | 0.45 | A |
| Com- | 0% by number | — | 0.80 | 1.15 | A |
| parative | | | | | |
| Example 1 | | | | | |
| Com- | 0.001% by number | PY74 | 0.75 | 1.10 | A |
| parative | | | | | |
| Example 2 | | | | | |
| Com- | 5.0% by number | PY74 | 0.90 | 1.20 | B |
| parative | | | | | |
| Example 3 | | | | | |
| Com- | 0.008% by number | PY74 | 0.80 | 1.10 | A |
| parative | | | | | |
| Example 4 | | | | | |
| Com- | 3.1% by number | PY74 | 0.80 | 1.20 | B |
| parative | | | | | |
| Example 5 | | | | | |

In Examples 1 to 9 in which the content ratio of the yellow toner particles is in the specific range, a change in the color of the image caused by the irradiation of ultraviolet rays is prevented, as compared to Comparative Example 1 in which the yellow toner particles are not added and Comparative Examples 2 and 4 in which the content ratio of the yellow toner particles is lower than the specific range.

In addition, in Examples 1, 3, and 6 in which a monoazo pigment or a diazo pigment is used as the yellow toner particles, a change in the color of the image caused by the irradiation of ultraviolet rays under the short-term irradiation condition is further prevented, as compared to Examples 4, 8 and 9 in which an isoindoline pigment is used as the yellow toner particles. On the other hand, in Examples 4, 8, and 9 in which an isoindoline pigment is used as the yellow toner particles, a change in the color of the image caused by the irradiation of ultraviolet rays under the long-term irradiation condition is further prevented, as compared to Examples 1, 3, and 6 in which a monoazo pigment or a diazo pigment is used as the yellow toner particles.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing white toner comprising:
a white toner particle; and
a yellow toner particle that includes an organic yellow pigment,
wherein a content ratio of the yellow toner particles to all of toner particles included in the toner is from 0.01% by number to 3% by number.

2. The electrostatic charge image developing white toner according to claim 1,
wherein the white toner particle includes at least one of titanium oxide and zinc oxide as a white pigment.

3. The electrostatic charge image developing white toner according to claim 1,
wherein the white toner particle includes titanium oxide as a white pigment.

4. The electrostatic charge image developing white toner according to claim 1,
wherein the yellow toner particle include at least one of a monoazo pigment and a diazo pigment as the organic yellow pigment.

5. The electrostatic charge image developing white toner according to claim 1,
wherein the yellow toner particle includes, as the organic yellow pigment, at least one pigment selected from the group consisting of C.I. Pigment Yellow 74, C.I. Pigment Yellow 155, and C.I. Pigment Yellow 180.

6. The electrostatic charge image developing white toner according to claim 1,
wherein the yellow toner particle includes an isoindoline pigment as the organic yellow pigment.

7. The electrostatic charge image developing white toner according to claim 1,
wherein the yellow toner particle includes, as the organic yellow pigment, at least one pigment selected from the group consisting of C.I. Pigment Yellow 139 and C.I. Pigment Yellow 185.

8. The electrostatic charge image developing white toner according to claim 1,
wherein the yellow toner particles include the organic yellow pigment in an amount of from 2% by weight to 20% by weight with respect to a total amount of the yellow toner particles.

9. The electrostatic charge image developing white toner according to claim 1,
wherein the white toner particles include a white pigment in an amount of from 15% by weight to 70% by weight with respect to a total amount of the white toner particles.

10. An electrostatic charge image developer comprising:
a carrier; and
the electrostatic charge image developing white toner according to claim 1.

11. A toner cartridge comprising:
a container that contains the electrostatic charge image developing white toner according to claim 1,
wherein the toner cartridge is detachable from an image forming apparatus.
